(19) United States
(12) Patent Application Publication
(10) Pub. No.: US 2022/0396388 A1
(43) Pub. Date: Dec. 15, 2022

(54) Liquid Fuel Storage Container

(71) Applicant: Christopher Berry, Hannibal, MO (US)

(72) Inventor: Christopher Berry, Hannibal, MO (US)

(21) Appl. No.: 17/839,255

(22) Filed: Jun. 13, 2022

Related U.S. Application Data
(60) Provisional application No. 63/209,785, filed on Jun. 11, 2021.

(51) Int. Cl. B65D 1/20; B65D 25/42; B65D 25/28

(52) U.S. Cl. CPC B65D 1/20; B65D 25/42; B65D 25/2894; B65D 25/2885

(57) ABSTRACT

A liquid fuel storage and transport container has a permanently attached pour spout, a refill component with an inside diameter of at least 0.8 inch which may be either permanently attached or removably attached, a hinged door covering the refill component, and at least one carry handle. Since the pour spout isn't removed each time the container is filled back up, it avoids developing leaks that occur when pouring fuel into a vehicle fuel tank.

### CROSS-REFERENCE TO RELATED APPLICATIONS

The present application claims priority from, and incorporates by reference in its entirety, U.S. provisional patent application 63/209,785.

### BACKGROUND

### Field of the Invention

The present invention relates to storage containers, and more specifically to storage containers for liquids.

### Description of Related Art

Conventional gas cans use a single hole for the fill hole and the pour hole. To fill the can up the user removes the nozzle. To empty the contents of the gas can into a vehicle tank the user replaces the nozzle and pours the gas through it.

### SUMMARY

The present inventor recognized a number of drawbacks with conventional gas cans. For example, the user must remove the nozzle, or the fill cap, each time the can is filled. Removing the nozzle or fill cap so often eventually results in the part being damaged—or sometimes lost—thus rendering the can useless for its stated purpose. Further, over time it becomes very difficult to get the nozzle or fill cap to seal tightly to the gas can. This is due to the fuel within the gas can warping the nozzle and/or the threaded hole over time, causing the parts to become mismatched. In order to get a conventional nozzle to seal well without dripping when gas is poured from the can, the nozzle must be tightened with a great deal of force. Each time the conventional gas is filled, it becomes slightly more difficult to loosen the nozzle which was tightened with increasingly great force to prevent drips, and then tightening it up again upon filling it. The various embodiments of the liquid fuel storage container disclosed herein overcome these drawbacks.

Embodiments disclosed herein address the above stated needs by providing a liquid fuel storage and transport container that has a permanently attached pour spout, a refill component with an inside diameter of at least 0.8 inch which may be either permanently attached or removably attached, a hinged door covering the refill component, and at least one carry handle. Since the pour spout isn't removed each time the container is filled back up, it avoids developing leaks that occur when pouring fuel into a vehicle fuel tank.

### BRIEF DESCRIPTION OF THE DRAWINGS

The accompanying drawings, which are incorporated in and constitute part of the specification, illustrate various embodiments of the invention. Together with the general description, the drawings serve to explain the principles of the invention. In the drawings:

FIGS. 1A-B depict side views of liquid fuel storage containers according to various embodiments.

FIG. 1C depicts top and bottom views of a liquid fuel storage container according to various embodiments.

FIGS. 2A-B depict perspective views of liquid fuel storage containers according to various embodiments.

FIG. 3A is a cutaway view depicting details of the hinged inlet port in a closed position according to various embodiments.

FIG. 3B is a cutaway view depicting details of the hinged inlet port in an open position according to various embodiments.

FIG. 3C is a cutaway view depicting details of a detachable hinged inlet port according to various embodiments.

### DETAILED DESCRIPTION

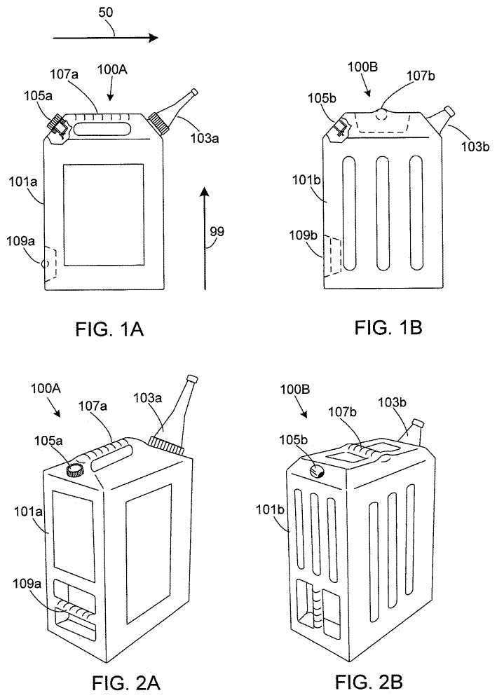

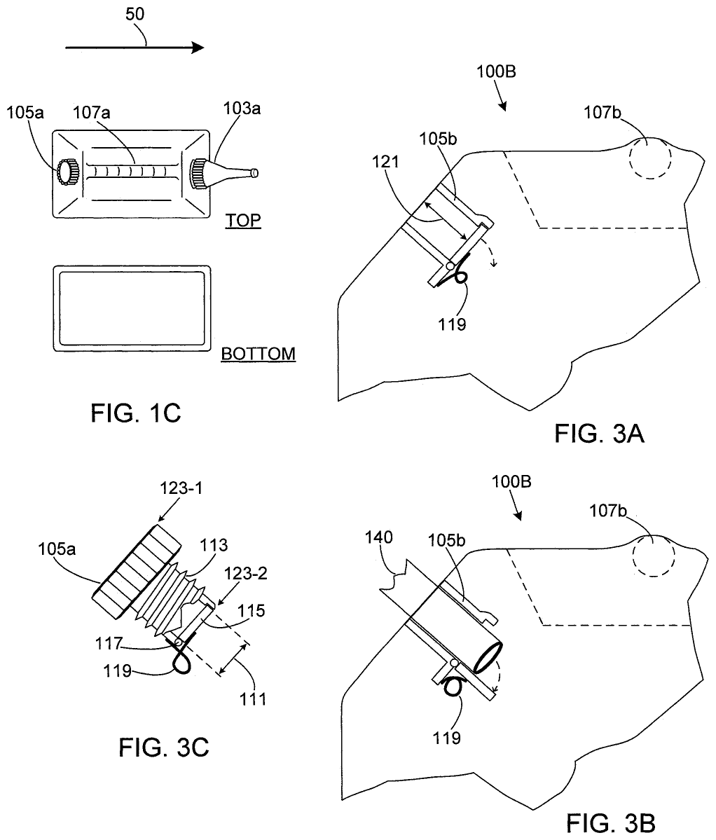

FIGS. 1A-B respectively depict side views of liquid fuel storage containers 100A-B according to various embodiments (sometimes called fuel storage containers 100A-B or simply liquid storage containers 100A-B). FIGS. 2A-B depict perspective views of liquid fuel storage containers 100A-B according to various embodiments. The liquid fuel storage containers 100A-B are actually liquid storage and transport container inasmuch as they are configured to hold a liquid (e.g., gasoline or diesel), have handles, and are small enough to be carried by a human user. The flat side panels of fuel storage containers 100A-B generally have ribs stamped into them, as shown in FIG. 1B, or have a flat indented panel stamped into the side, as shown in FIG. 1A, or bottom as shown in FIG. 1C. The ribs or flat indented panels add structural support to cannister bodies 101a-b.

The various embodiments of liquid fuel storage containers disclosed herein have both a pour spout 103a-b and a refill component 105a-b with an inlet hole passing through it on each canister. Conventional gas cans generally have only a single hole that serves as both the pour spout and the inlet hole. The present inventor recognized that the conventional single-hole approach—while less expensive to manufacture—gives rise to leaking due to repeated tightening/untightening with each use and refill. The pour spout 103a-b is sometimes called an output port, and the refill component 105a-b is sometimes called input port. The pour spout 103a-b has a proximal end that is attached to the cannister body 101a-b, and a distal end configured to pour the liquid contents of the liquid fuel storage container 100A-B.

The various embodiments disclosed herein have an upper handle 107a-b. Some embodiments have a lower handle 109a-b as well. The upper handle 107a-b and/or the lower handle 109a-b may be recessed to avoid catching on something and tip the container over. FIG. 1B and FIG. 2B depict embodiments with recessed handles. The upper and lower handles 107/9a-b are designed to be grasped by a human user. As such, various embodiments of the portion of the handle to be held by a human user is typically no greater than 3.25 inches in diameter. More commonly, the diameter of the upper and lower handles 107/9a-b is no greater than 2.25 inches. The cross-section of the handles need not be round, in some instances being an oval or a flattened circle. The diameter is measured across the wide dimension in the center of the portion of the handle to be gripped by a user—e.g., about where the user's middle finger would grip. The upper handles 107a-b may either be oriented in spout planar direction 50 (FIG. 1A) or may be oriented orthogonal to the spout planar direction 50 (FIG. 1B). Based on these orientations, the handles of fuel storage container 100A are called a planar upper cannister handle 107a and an orthogonal lower cannister handle 109a. The planar upper cannister handle 107a is in the plane of the spout planar direction 50 and the upward direction 99.

FIG. 1C depicts a top view of liquid fuel storage containers 100A which illustrates the cannister handle 107a oriented in spout planar direction 50. The top view shows the top portion of liquid fuel storage containers 100A of FIG. 1A as viewed looking downward (opposite the upward direction 99 of FIG. 1A). The bottom view shows the bottom face of liquid fuel storage containers 100A of FIG. 1A looking as viewed in the upward direction 99. The terms top “portion” as opposed to bottom “face” are used since the top portion may be irregularly shaped. The bottom face is typically flat or has at least has three of its lowest points (e.g., legs) oriented in a plane in order to sit flat on a floor or shelf without tilting or rocking. By contrast the top portion is not necessarily be flat as can be seen in FIGS. 1A-B. The “top portion” consists of those parts of the top one third (in height) of cannister body 101a-b that are seen from above in looking downward.

The pour spout 101 may be funnel shaped or otherwise slanted away from a corner or edge of the can so as to facilitate fully emptying the liquid fuel storage container. The pour spouts 103a-b may be funnel shaped or otherwise slanted away from a side or corner of the cannister bodies 101a-b so as to facilitate fully emptying the liquid fuel storage container. The pour spout 103a-b may have a removable cap as shown in the figures that either screws on or fits tightly through friction. It should be noted that spout planar direction 50 is planar to the orientation of pour spout 103a but not necessarily parallel to the centerline of pour spout 103a, as can be seen in viewing both FIG. 1A and FIG. 1C. Spout planar direction 50 is orthogonal to upward direction 99. Liquid fuel storage container 100B has an orthogonal upper cannister handle 107b and a planar lower cannister handle 109b. Some users feel that the planar upper cannister handle 107a shown in FIG. 1A is more ergonomically suited for carrying a fuel storage container, but the orthogonal upper cannister handle 107b of FIG. 1B may be better suited for pouring fuel into a vehicle.

As used herein the phrase liquid fuel storage container 100A includes all the components depicted in FIG. 1A including the detachable components. The cannister body 101a (for holding fuel) includes the components formed from its material, or permanently affixed to the cannister body 101a. Cannister body 101b has a permanently affixed pour spout 103b and a permanently affixed hinged refill component 105b. The permanently affixed pour spout 103b and the permanently affixed hinged refill component 105b may either be formed from the canister material at the time the cannister body 101b was formed, or may be permanently attached to the cannister body 101b. Both of these permanently attached components are considered to be part of the cannister body 101b as well as liquid fuel storage container 100B by virtue of being permanently attached. On the other hand, liquid fuel storage container 100A has a detachable pour spout 103a and detachable refill component 105a. Since they are detachable these two components are part of liquid fuel storage container 100A, but are not considered part of cannister body 101a. The cannister body 101a-b, pour spout 103a-b and hinged refill component 105a-b are typically made from one or more materials impervious to liquids such as metal, plastic, glass or other man-made material known to those of ordinary skill in the art to be suitable for containers that hold liquids,

FIG. 3A is a cutaway view depicting details of permanently affixed hinged refill component 105b in the closed position. FIG. 3B is a cutaway view depicting details of permanently affixed hinged refill component 105b in the open position. FIG. 3C is a cutaway view depicting details of detachable refill component 105a. The refill components 105a-b are mounted on a hole in the cannister body 101a-b either detachably or permanently. The refill components 105a-b have an inlet hole passing through the component from an outside edge 123-1 to an inside edge 123-2. The outside edge 123-1 is outside the cannister body 101a-b and the inside edge 123-2 is inside of it, thus allowing access to the interior of the cannister body 101a-b for filling it up. Both of the refill components 105a and 105b have a hinge-spring component 119 configured to keep the refill component closed if the fuel storage container 100A-B is not being filled. The hinge spring-component 119 may be made from materials including: a spring, a piece of spring steel, rubber, plastic or other man-made material, or other like types of material known to those of ordinary skill in the art to have elastic characteristics sufficient to push the hinged door 115 to a closed position if no fuel nozzle 140 is inserted in the refill components 105a-b.

To fill the liquid fuel storage container 100A-B a fuel nozzle 140 (e.g., gas pump nozzle) is inserted into the refill component 105a-b to open the hinged door 115, as shown in FIG. 3B. The hinged door 115 has a hinge mechanism 117 that allows it to be pushed open—e.g., by the fuel nozzle 140. In this way the hinged door 115 is rotatably attached to the refill components 105a-b. The hinge mechanism 117 may be implemented as a small barrel hinge, an overlay hinge, an offset hinge, pin-and-hole mechanism, or any other structure that allows two components to hinge relative to each other as are known by those of ordinary skill in the art. The distance of hinged door 115 from the outer surface of the hinged refill component 105a-b is known as the hinged door depth 121. If the hinged door 115 is located too far down in the hinged refill component 105a-b it would be too far down for a gas pump nozzle 140 to reach and open it. Therefore, the various embodiments have a hinged door depth 121 that is no greater than 4 inches. Some embodiments have a hinged door depth 121 of no more than 3.0 inches, other embodiments have a hinged door depth 121 of no more than 1.5 inches, while other embodiments have a hinged door depth 121 of no more than 1.0 inches. The hinged door depth 121 may be 0.0 inches for embodiments in which the hinged door 115 is flush with the outer surface of the hinged refill component 105a-b. Some embodiments may have a negative hinged door depth 121—for example, in configurations where the hinged door 115 protrudes outward slightly from the surface of the cannister body 101b making it easier to find in the dark.

Turning to FIG. 3A-B and FIG. 3C, in situations where the liquid fuel storage container 100A-B is not being filled the hinged door 115 remains in a closed position as shown in FIG. 3A and 3C. The hinge-spring component 119 pushes against the hinged door 115 with sufficient force to keep it closed—e.g., at least 0.025 Newtons or greater. In some embodiments the hinged refill component 105a-b may have an O-ring or gasket that comes in contact with the hinged door 115 in a closed position so as to produce a seal that prevents liquid from leaking from the hinged refill component 105a-b. Such embodiments are useful in situations where the liquid fuel storage container 100A-B may possibly be tipped over at some point or are subject to severe motion that violently sloshes the fuel around in the contain—e.g., on board a seagoing vessel in rough seas or in a moving truck or other vehicle traveling over rough terrain. Such embodiments may be called leak-proof refill components 105a-b, depending upon testing results described below. These assemblies differ from the hinged door on a vehicle's gasoline tank under the fill cap. The hinged door on a vehicle gasoline tank is purposely designed to pass some amount of air to avoid creating a negative air pressure as fuel is used by the vehicle. In other embodiments disclosed herein, the hinged refill component 105a-b is designed to allow a limited amount of air to pass into the cannister bodies 101a-b as fuel is being poured out. Such embodiments are able to prevent substantial leakage of fuel from the hinged refill component 105a-b with the fuel storage container 100A-B sitting upright—e.g., sitting on a shelf or floor, or being transported in a vehicle—even if fuel is being sloshed around a bit within cannister bodies 101a-b. Such embodiments may be called a slosh-proof hinged refill component 105a-b, depending upon testing results described below.

The liquid fuel storage container is primarily designed for liquid fuels such as gasoline, diesel, kerosene, fuel oil, or various other types of liquid fuels or oils known to those of ordinary skill in the art. However, the liquid fuel storage container may be used with any type of liquid, including for example, water, antifreeze, window washer fluid, liquid detergents, liquid fertilizers, pesticides and any other liquid of sufficient viscosity to be poured through a spout.

FIG. 3C is a cutaway view depicting details of a detachable refill component 105a according to various embodiments. The detachable refill component 105a serves as the inlet hole for filling the liquid fuel storage container 100A. Typically, the detachable refill component 105a has male threads 113 configured to screw into female threads formed on the fuel storage container 100A. In other implementations the detachable refill component 105a may have female threads. The detachable spout 103a may be attached in a similar manner. Other structures may be implemented for attaching the detachable refill component 105a as well as the detachable spout 103a, including for example: a clamping mechanism, a pressure fitted orifice, screws, bolts/nuts, or other like types of structures known to those of ordinary skill in the art for attaching two components. Liquid fuel storage container 100B of FIG. 1B and FIGS. 3A-B has a permanently affixed hinged refill component 105b and a permanently affixed pour spout 103b that serves as the output port for pouring liquid fuels out of the container 100B.

The inside hole diameter 111 of the inlet hole shown in FIG. 3C is a feature of detachable refill component 105a, and also a feature of the permanently affixed hinged refill component 105b. Typically, the inlet hole diameter 111 is implemented to be at least slightly larger than the fuel nozzle 140 to be inserted. For unleaded gasoline, the fuel nozzle 140 has a diameter of 0.75 inch. Therefore, the various embodiments for use with unleaded gasoline have an inlet hole diameter 111 of at least 0.80 inch or more. For other uses, the inside hole diameter 111 may be implemented smaller. In some implementations the inlet hole may not be cylindrical, instead having a slight taper. In such implementations the inlet hole diameter 111 is the smallest measurement of the tapered inlet hole, generally at the point adjacent the hinged door 115.

The liquid fuel storage containers 100A-B are actually liquid storage and transport container inasmuch as they are configured to hold a liquid (e.g., gasoline, diesel or other type of liquid), have handles for carrying them, and are small enough to be carried by a human user. A typical size might be from one to five gallons. A five-gallon container filled with liquid fuel (e.g., gasoline or diesel) could easily weigh 37 pounds or so. It is possible to have a ten gallon—or even a twenty gallon—liquid storage and transport container. A maximum volume size to be considered a liquid storage and transport container is twenty-five gallons. Containers larger than this are too unwieldy to be carried by a typical human user. For example, a fifty-gallon container would weigh over 350 pounds, and thus be too large to be considered a liquid storage and transport container. An average human user could not lift such a container.

For illustrative purposes the discussion herein has provided explanation referring to liquid fuel storage containers. Indeed, the most common and valuable use of the various embodiments may be for the storage and transport of liquid fuel. However, the containers described and claimed herein may be used for any sort of liquids, including but not limited to: water, cooking oil, pesticides, liquid fertilizers, week killers, or other like types of liquids known to those of ordinary skill in the art.

The upward direction 99 points in a direction away from the center of the earth. The spout planar direction 50 is perpendicular to the upward direction 99, and is parallel to the plane formed by a line bisecting the spout 103a and the upward direction 99. For spouts that are curved (and thus do not have a single line bisecting them), the line bisecting the spout 103a is considered to be the line extending outward perpendicular from the center of the spout hole—that is, the hole in cannister body 101a that detachable pour spout 103a attaches to.

The term “permanently affixed” (sometimes called permanently attached) as used herein means that a given component may not be removed from an item without damaging either the given component or the item to which it is permanently affixed, or damaging the structure for permanently affixing the two components. A component formed from the same piece of material is considered permanently affixed. For example, the glass handle of a coffee cup formed at the time the coffee cup was made is considered to be a permanently affixed component of the coffee cup. Further, a metal component welded onto a metal assembly is considered to be permanently affixed. Two pieces of metal riveted to each other are also considered permanently affixed since, although the pieces of metal may possibly be separated without damaging either one, the rivet used to attach them together will become ruined. By contrast, two pieces of metal held together with a bolt and nut are not considered to be permanently affixed to each other. Hinged refill component 105b depicted in FIG. 1B is permanently affixed to the liquid fuel storage container 100B inasmuch as an attempt to remove it (e.g., cut out the refill hole 105b) would result in damaging the liquid fuel storage container 100B. Hinged refill component 105a depicted in FIG. 1A and FIG. 3C is not permanently affixed since it may be removed without damaging the refill component 105a or the liquid fuel storage container 100A. Two components that are “rotatably attached” can move relative to each other—that is, hinge back and forth. The horseshoe shifter of a 1971 Chevelle is rotatably attached to its shifter base plate. The hinged door 115 is rotatably attached to the refill components 105a-b.

The refill components 105a-b disclosed herein are aimed mostly at ease of opening rather than being fully leak-proof. The paragraphs above disclose a leak-proof refill component 105a-b and a slosh-proof refill component 105a-b. However, even the leak-proof and slosh-proof refill components 105a-b leak a small amount. These terms axe defined under the following repeatable test conditions that measure the amount of liquid leaked in a specified period of time, as measured at standard atmospheric temperature and pressure. The test apparatus consists of a flat-bottomed water contain with side walls six inches apart and filled initially with one foot of water. A hinged refill component 105a-b is installed on the flat bottom, and the rate of water leakage through the hinged refill component 105a-b is measured. A leak-proof hinged refill component 105a-b allows no more than one ounce of water to pass each minute. A slosh-proof hinged refill component 105a-b leaks no more than four ounces of water to pass each minute. A hinged refill component 105a-b that leaks more than four ounces per minute in this test apparatus is neither leak-proof nor slosh-proof. The phrase “a cannister body comprising leak-proof material” means that the cannister body is made from leak-proof material impervious to the liquid it is designed to hold—e.g., gasoline, diesel, water or the like.

The description of the various embodiments provided above is illustrative in nature inasmuch as it is not intended to limit the invention, its application, or uses. Thus, variations that do not depart from the intents or purposes of the invention are intended to be encompassed by the various embodiments of the present invention. Such variations are not to be regarded as a departure from the intended scope of the present invention.

What is claimed is:

1. A liquid storage and transport container, comprising:
a cannister body comprising leak-proof material, the cannister body including a top portion, a bottom face and a side portion, the bottom face having at least three lowest points oriented in a plane;
a pour spout with a proximal spout end and a distal spout end, the proximal spout end being affixed to the cannister body;
a refill component affixed to the cannister body, the refill component being positioned to pass through a hole in the cannister body, the refill component having an outside edge and an inside edge and being configured with an inlet hole passing from the outside edge to the inside edge;
a hinged door rotatably attached to the refill component, the hinged door being configured to open to an open position in response to a nozzle being inserted into the inlet hole of the refill component;
a hinge-spring component configured to move the hinged door to a closed position in response to the nozzle being removed from the inlet hole of the refill component; and
a handle permanently affixed to the cannister body, the handle having a diameter of no greater than 2.5 inches.

2. The liquid storage and transport container of claim 1, wherein the handle is an upper handle affixed to the top portion of the cannister body, the apparatus further comprising:
a lower handle permanently affixed to the side portion of the cannister body, the lower handle having a diameter of no greater than 2.5 inches.

3. The liquid storage and transport container of claim 1, wherein the proximal spout end is permanently affixed to the cannister body.

4. The liquid storage and transport container of claim 3, wherein the handle has a diameter of no greater than 2.0 inches; and
wherein the refill component is removably affixed to the cannister body.

5. The liquid storage and transport container of claim 4, wherein the refill component has male threads that removably affix the refill component to the cannister body.

6. The liquid storage and transport container of claim 4, wherein the hinge-spring component is spring steel; and
wherein the inlet hole has a diameter of at least 0.8 inch.

7. The liquid storage and transport container of claim 4, wherein the handle is an orthogonal upper handle affixed to the top portion of the cannister body, the liquid storage and transport container further comprising:
a planar lower handle permanently affixed to the side portion of the cannister body, the lower handle having a diameter of no greater than 2.5 inches.

8. The liquid storage and transport container of claim 1, wherein the proximal spout end is permanently affixed to the cannister body; and
wherein the refill component is permanently affixed to the cannister body.

9. The liquid storage and transport container of claim 1, wherein refill component is a slosh-proof refill component.

10. The liquid storage and transport container of claim 1, wherein the cannister body holds a volume of no more than 5.0 gallons.

11. The liquid storage and transport container of claim 1, wherein the cannister body holds a volume of no more than 2.5 gallons.

12. A liquid storage and transport container, comprising:
a cannister body comprising leak-proof material, the cannister body including a top portion, a bottom face and a side portion, the bottom face having at least three lowest points oriented in a plane, wherein the cannister body holds a volume of no more than 2.5 gallons;
a pour spout with a proximal spout end and a distal spout end, the proximal spout end being permanently affixed to the cannister body;
a refill component affixed to the cannister body, the refill component being positioned to pass through a hole in the cannister body, the refill component having an outside edge and an inside edge and being configured with an inlet hole passing from the outside edge to the inside edge, wherein the inlet hole has a diameter of at least 0.8 inch;
a hinged door configured as part of the refill component, the hinged door being configured to open to an open position in response to a nozzle being inserted into the inlet hole of the refill component;
a hinge-spring component configured to move the hinged door to a closed position in response to the nozzle being removed from the inlet hole of the refill component;
an orthogonal upper handle permanently affixed to the top portion of the cannister body, the orthogonal upper handle having a diameter of no greater than 1.75 inches; and
a planar lower handle permanently affixed to the side portion of the cannister body, the lower handle having a diameter of no greater than 1.75 inches.
